(19) United States
(12) Patent Application Publication
(10) Pub. No.: US 2012/0106934 A1
(43) Pub. Date: May 3, 2012

(54) DIFFUSION FURNACE

(75) Inventors: MING-HUI YU, TAIPEI CITY (TW); CHIA-JUNG KAO, TAIPEI CITY (TW); A-TZU CHEN, NEW TAIPEI CITY (TW); WANG-TSUNG LIANG, TAOYUAN COUNTY (TW); CHANG-FA CHEN, Taoyuan County (TW)

(73) Assignee: TANGTECK EQUIPMENT INC., Taoyuan County (TW)

(21) Appl. No.: 13/231,923

(22) Filed: Sep. 13, 2011

(30) Foreign Application Priority Data
Oct. 27, 2010 (TW) 99220775

(51) Int. Cl. F26B 3/30

(52) U.S. Cl. 392/411

(57) ABSTRACT

A diffusion furnace is disclosed, which includes an outer housing, an inner housing, and a plurality of infrared heating elements. The inner housing is arranged within the outer housing, and a chamber is formed inside of the inner housing. A portion of each infrared heating element is arranged on the outer housing. Each of the infrared heating elements has a heating portion and at least one fixing portion connected thereto. The heating portion of each infrared heating element is arranged within the outer housing. The fixing portion of each infrared heating element is secured onto the outer housing. Therefore, the heating elements would neither distort nor have any issues in staying secured to the furnace. Moreover, the furnace can be cooled down more quickly after operation.

### BACKGROUND OF THE INVENTION

1. Field of the Invention

The instant disclosure relates to a diffusion furnace; more particularly, to a diffusion furnace having a plurality of partially exposed infrared heating elements.

2. Description of Related Art

In general, the fabrication of CIGS (copper indium gallium selenide) thin-film solar cell (TFSC) involves the following procedures. First, a molybdenum layer (Mo), serving as a back contact, will be coated on a substrate (such as glass, stainless steel, etc.). Then, a CIGS precursor film of corresponding thickness is formed on the molybdenum layer. The deposition of copper (Cu), indium (In), and gallium (Ga) film can be done by methods including physical vapor deposition (PVD), electro-less plating, and electroplating. Then, the substrate having a film that comprises copper, indium, and gallium is placed in a diffusion furnace with selenide vapor introduced therein and undergoes an annealing process under high temperature condition (typically between 500˜600 degree Celsius) to form the final CIGS thin film.

A diffusion furnace usually has a plurality of heating elements. Conventional heating elements generally consist of heating wires recessively arranged in the ceramic insulating layer of the furnace. However, these heating elements may deform due to thermal expansion, which can cause premature failures and misplacements of the heating elements. In addition, when power is cut off to the heating wires, a majority of residual heat in the device will remain in the ceramic insulating layer. Therefore, the furnace can not quickly cool down after operation.

To address the above issues, the inventors strive via industrial experience and academic research to present the instant disclosure, which can effectively improve the limitations described above.

### SUMMARY OF THE INVENTION

The instant disclosure relates to a diffusion furnace. The heating elements of this diffusion furnace would not deform due to thermal expansion. The heating elements can be firmly secured and cool down quickly after operation.

The diffusion furnace of the instant disclosure comprises an outer housing, an inner housing, and a plurality of infrared heating elements. The inner housing is arranged inside the outer housing, and a chamber is formed within the inner housing. At least a portion of each infrared heating element is disposed on the outer housing. Each of these infrared heating elements has a heating portion and a fixing portion connected thereto. The heating portion is positioned inside of the outer housing, and the fixing portion is secured externally on the outer housing.

The instant disclosure also provides a diffusion furnace that comprises an outer housing, an inner housing, and a plurality of infrared heating elements. The inner housing is arranged within the outer housing, and a chamber is formed within the inner housing. At least a portion of each infrared heating element is disposed on the outer housing. Each of these infrared heating elements has a heating portion, each of which is positioned inside of the outer housing.

The diffusion furnace of the instant disclosure has the following advantages. The infrared heating elements do not distort due to thermal expansion. Such ability allows the infrared heating elements to be free from premature failures and be fixed securingly. Moreover, after the power is turned off, the infrared heating elements retain less residual heat. Therefore, the furnace can cool down more quickly after operation.

In order to further appreciate the characteristics and technical contents of the instant disclosure, references are hereunder made to the detailed descriptions and appended drawings in connection with the instant disclosure. However, the appended drawings are merely shown for exemplary purposes, rather than being used to restrict the scope of the instant disclosure.

### BRIEF DESCRIPTION OF THE DRAWINGS

FIG. 1 is a perspective view of a diffusion furnace of the instant disclosure.

FIG. 2 is a perspective view of a portion of the diffusion furnace of the instant disclosure.

FIG. 3 is a cross-sectional view of the diffusion furnace of the instant disclosure.

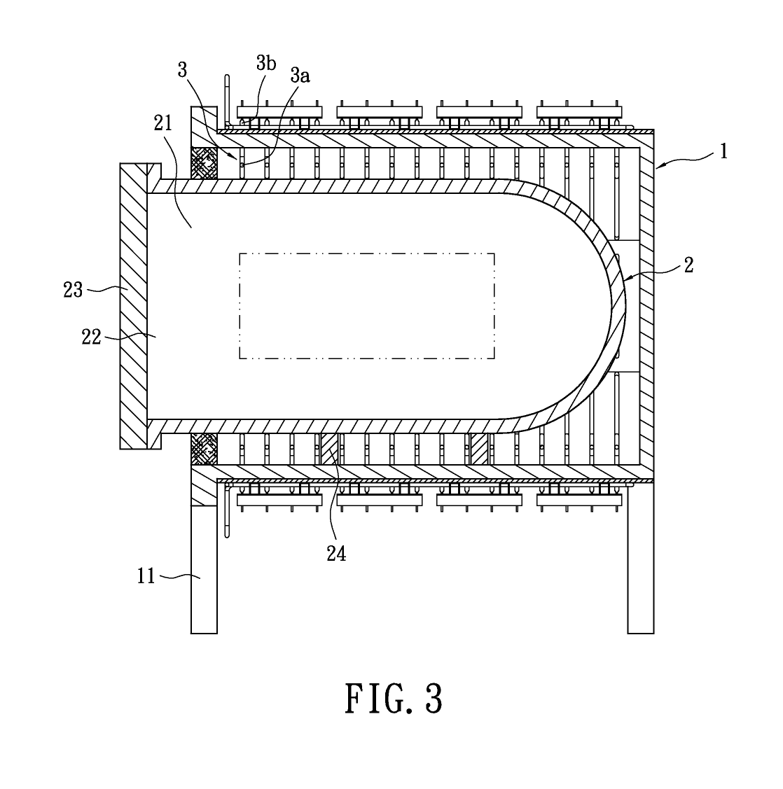

FIG. 4 is a perspective view of an infrared heating element of the instant disclosure.

FIG. 5 is a block diagram showing the control sequence of a heating unit of the instant disclosure.

### DETAILED DESCRIPTION OF PREFERRED EMBODIMENTS

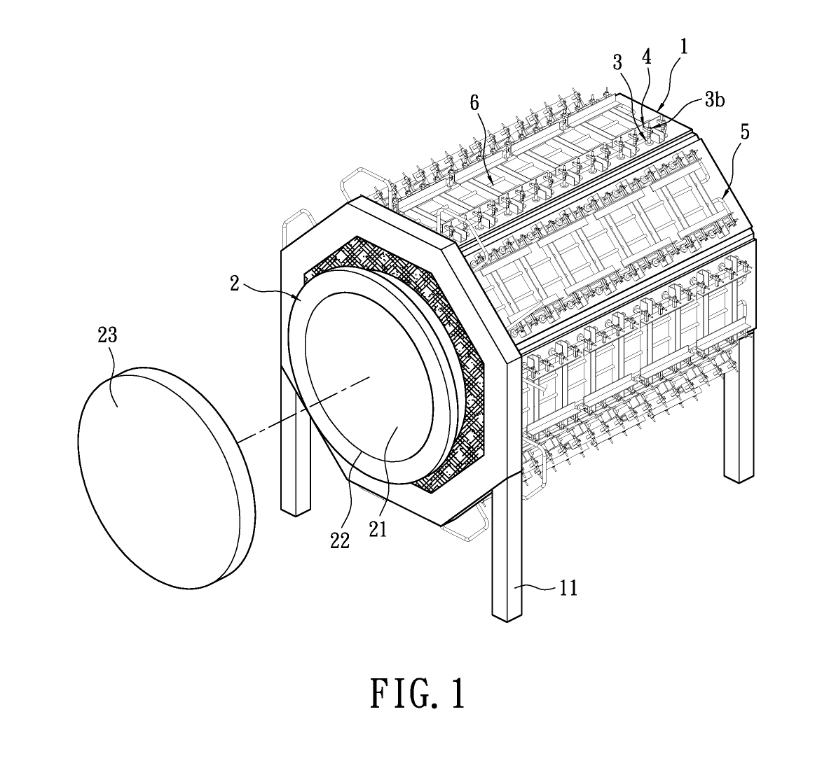

Please refer to FIGS. 1˜4. The instant disclosure provides a diffusion furnace. The diffusion furnace can be used for the manufacturing of CIGS solar cell and other diffusion processes. During the furnace operation, reactant gases can be introduced into the furnace through an inlet (not shown). The diffusion furnace comprises an outer housing 1, an inner housing 2, and a plurality of infrared heating elements 3. The outer housing 1 has an internal cavity formed therein. The shape of the outer housing 1 can be circular, polygonal, rectangular, or any other form without restriction. For the instant embodiment, the outer housing 1 has a polygonal shape. The outer housing 1 is generally made of the fire-retardant material (insulation). An opening is formed at least on one end of the outer housing 1, for receiving at least a portion of the inner housing 2 in the cavity of the outer housing 1. The outer housing 1 can be supported by at least one leg 11. The leg 11 is used to elevate the outer housing 1 to a proper height off the ground. The structural configuration of the leg 11 is not restricted.

The inner housing 2 is a hollowed structure, which is fabricated of quartz or other materials. The inner housing 2 is arranged within the outer housing 1, and a chamber 21 is defined by the hollowed structure of the inner housing 2. An opening 22 is formed at least on one end of the inner housing 2. The chamber 21 communicates with the opening 22 to accept objects for thermal treatment. A metallic cover 23 can be arranged over the opening 22, and a furnace door (not shown) can be mounted on the cover 23. At least two support members 24 fabricated of fire brick can be used for mounting the inner housing 2 within the outer housing 1.

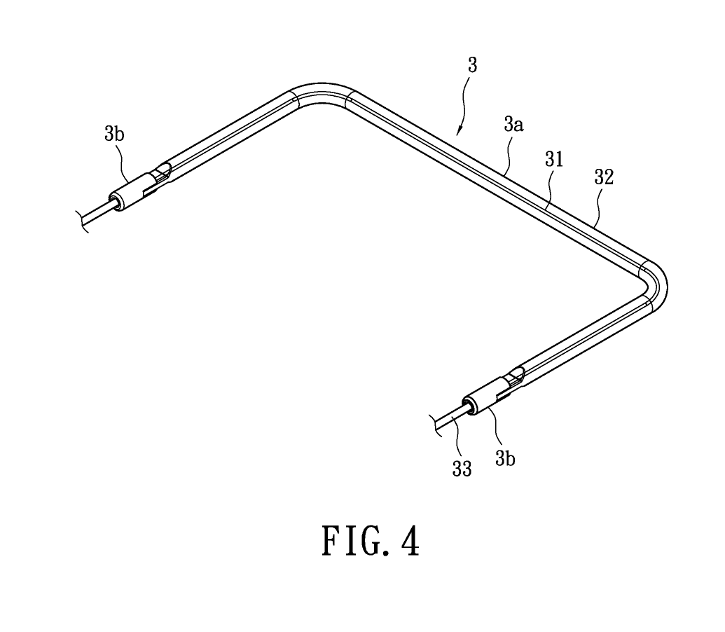

The shape and structural configuration of the infrared heating elements 3 are not restricted. For this embodiment, the infrared heating elements 3 use a filament 31 as the emitting body, such as a tungsten wire. The filament 31 is protected within a quartz tube 32, as shown in FIG. 4. The filament 31 is connected to the electrical wire 33. After the filament 31 is turned on, infrared energy is emitted through the quartz tube 32 for heating applications. Each infrared heating element 3 has a heating portion 3a and at least one fixing portion 3b connected thereto. In this embodiment, the infrared heating elements 3 are U-shaped, each of which has one heating portion 3a, and a fixing portion 3b is connected at either end of the heating portion 3a.

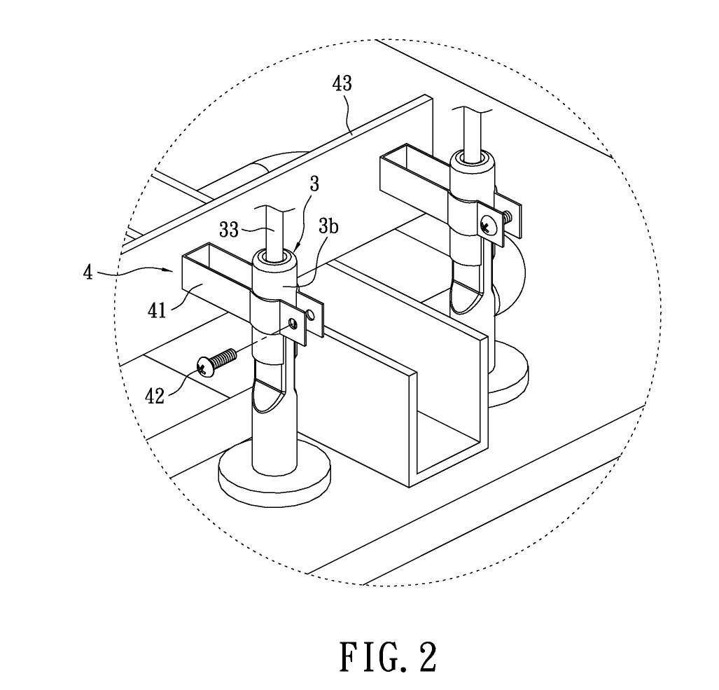

Each infrared heating element 3 is partially mounted on the outer housing 1, while the heating portion 3a is arranged within the outer housing 1. The heating portion 3a and the inner wall of the outer housing 1 have a clearance formed therebetween. The two fixing portions 3b of each infrared heating element 3 are secured on the outer housing 1. As shown in FIG. 2, the two fixing portions 3b of each infrared heating element 3 protrude from the outer housing 1. The fixing portions 3b are secured by a plurality of mounting devices 4. The mounting devices 4 are not restricted structurally. In this embodiment, each mounting device 4 includes a clamping member 41 and a fastener 42. For example, the clamping member 41 can be a U-shaped resilient strip. One end of the clamping member 41 is fixed onto a support frame 43, which is disposed on the outer surface of the outer housing 1. The opposite end of the clamping member 41 is used for clamping the fixing portion 3b of the infrared heating element 3. The fastener 42, such as a bolt, is used to tighten the clamping member 41. Thus, the two fixing portions 3b of each infrared heating element 3 are fixed to the corresponding mounting devices 4. These mounting devices 4 enable the infrared heating elements 3 to be secured onto the outer housing 1. Cooling pipes 5 can be further mounted on the outer housing 1. The cooling fluid within the cooling pipes 5 can help to reduce the furnace temperature.

After the infrared heating elements 3 are turned on, the emitted infrared energy is used to heat up the inner housing 2 and the objects within the chamber 21. The reactant gases can also be introduced into the diffusion furnace for pre-determined thermal treatment process.

The diffusion furnace of the instant disclosure utilizes the infrared heating elements 3 as the heat source for thermal treatment. The fixing portions 3b of each infrared heating element 3 can protrude from the outer housing 1. The protruded fixing portions 3b are secured to the outer housing 1 by the corresponding mounting devices 4. The infrared heating elements 3 are fabricated of quartz tubes 32. Therefore, the heating elements would not distort due to thermal expansion, which can prevent premature failures and ensure the heating elements to be firmly secured to the outer housing 1. In addition, after the infrared heating elements 3 are powered off, less residual heat is retained by the infrared heating elements 3. Thus, the infrared heating elements 3 have a higher cooling rate. Moreover, the infrared heating elements 3 can heat rapidly and have more uniform heat distribution.

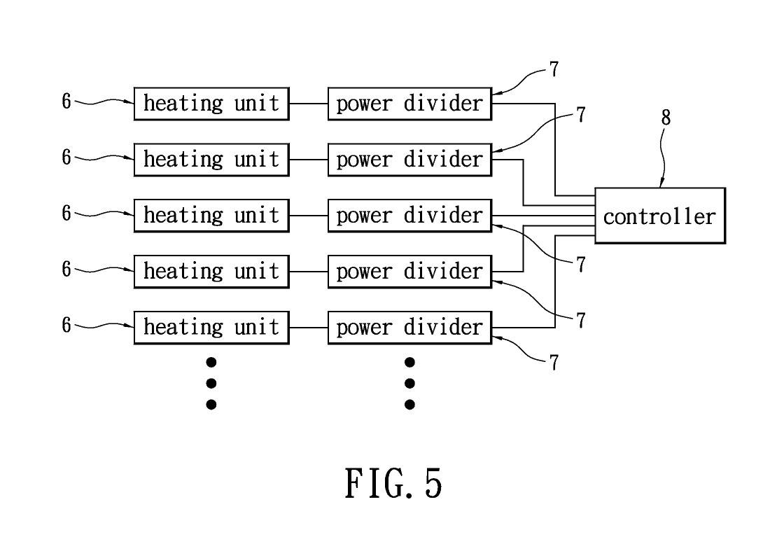

Please refer to FIG. 5. For the instant disclosure, the infrared heating elements 3 can be divided into a plurality of heating units 6. These heating units 6 are connected electrically to respective power dividers 7. Each heating unit 6 can have its own setpoint temperature. Alternatively, a common setpoint temperature can be shared by multiple heating units 6. The power dividers 7 are connected electrically to a controller 8. The controller 8 controls the power distributions to the heating units 6 electronically in forming a control system. Each heating unit 6 can be independently controlled to maintain uniform heat distribution for the chamber 21.

The descriptions illustrated supra set forth simply the preferred embodiment of the instant disclosure; however, the characteristics of the instant disclosure are by no means restricted thereto. All changes, alternations, or modifications conveniently considered by those skilled in the art are deemed to be encompassed within the scope of the instant disclosure delineated by the following claims.

What is claimed is:

1. A diffusion furnace, comprising:
an outer housing;
an inner housing arranged in the outer housing, the inner housing having a chamber formed therein; and
a plurality of infrared heating elements fixedly disposed on the outer housing, each infrared heating element having a heating portion and a structural connected fixing portion, wherein the heating portion of the infrared heating element is arranged in the outer housing, while the fixing portion of the infrared heating element is secured externally on the outer housing.

2. The diffusion furnace of claim 1, wherein the infrared heating element is U-shaped, and wherein the infrared heating element has a heating portion and two fixing portions connected at opposite ends of the heating portion.

3. The diffusion furnace of claim 1, wherein the inner housing is made of quartz.

4. The diffusion furnace of claim 1, wherein an opening is formed at least on one end of the inner housing, wherein the diffusion furnace further includes a metal cover for disposing over the opening, and wherein the inner housing is mounted within the outer housing by at least two support members.

5. The diffusion furnace of claim 1, wherein each of the infrared heating elements includes a filament protected within a quartz tube, and wherein the filament is connected to an electrical wire.

6. The diffusion furnace of claim 1, wherein the fixing portion of the infrared heating element is secured by a mounting device.

7. The diffusion furnace of claim 6, wherein the mounting device includes a clamping member and a fastener, wherein one end of the clamping member is secured to a support frame mounted on the outer housing, while an opposite end of the clamping member clamps to the fixing portion of the corresponding infrared heating element, and wherein the fastener is projected through the clamping member to tighten the clamping member.

8. The diffusion furnace of claim 1, wherein the infrared heating elements are divided into a plurality of heating units, with each heating unit connected electrically to a power divider, wherein the heating units have a temperature setpoint, and wherein the power dividers are connected electrically to a controller for controlling the power distribution to the heating units.

9. A diffusion furnace, comprising:
an outer housing;
an inner housing arranged in the outer housing, the inner housing having a chamber formed therein; and
a plurality of infrared heating elements fixedly disposed on the outer housing, each infrared heating element having a heating portion and a structural connected fixing portion, wherein the heating portion of the infrared heating element is arranged in the outer housing.

10. The diffusion furnace of claim 9, wherein the infrared heating elements are divided into a plurality of heating units, with each heating unit connected electrically to a power divider, wherein the heating units have a temperature setpoint, and wherein the power dividers are connected electrically to a controller for controlling the power distribution to the heating units.

11. The diffusion furnace of claim 9, wherein a fixing portion of the infrared heating element is secured by a mounting device.

12. The diffusion furnace of claim 11, wherein the infrared heating elements are divided into a plurality of heating units, with each heating unit connected electrically to a power divider, wherein the heating units have a temperature setpoint, and wherein the power dividers are connected electrically to a controller for controlling the power distribution to the heating units.
